(19) United States
(12) Patent Application Publication
(10) Pub. No.: US 2022/0169796 A1
(43) Pub. Date: Jun. 2, 2022

(54) Compounds that can be crosslinked by way of hydrosilylation reaction

(71) Applicant: Wacker Chemie AG, Munich (DE)

(72) Inventors: Wolfgang Ziche, Burghausen (DE); Markus Winterer, Simbach (DE)

(73) Assignee: Wacker Chemie AG, Munich (DE)

(21) Appl. No.: 17/442,061

(22) PCT Filed: Mar. 22, 2019
(86) PCT No.: PCT/EP2019/057312

§ 371 Date: Sep. 22, 2021

(51) Int. Cl. C08G 77/08; C08G 77/20; B01J 31/28; C08L 83/04; C08G 77/12

(52) U.S. Cl. CPC C08G 77/08; C08G 77/20; C08G 77/12; C08L 83/04; B01J 31/28

(57) ABSTRACT

A platinum-catalyzed composition along with a process for producing the same and a shaped body or products made from the same. The platinum-catalyzed composition is crosslinkable by a hydrosilylation reaction. The composition includes strong acids (S) having a pKa of <2.5 is less than 0.3 ppm by weight The platinum catalysts are those having the formula R¹₃Pt{CpR²₅} wherein Cp is the cyclopentadienyl radical and R¹ may be identical or different and is a monovalent, optionally substituted, aliphatically saturated hydrocarbon radical. R² may be identical or different and is a hydrogen atom, SiC-bonded silyl radical or a monovalent, optionally substituted hydrocarbon radical.

The present invention relates to compositions crosslinkable by hydrosilylation reaction, in particular those that comprise platinum catalysts activatable by ultraviolet and/or visible radiation, to the production thereof, to the use thereof, and to the crosslinking products produced therefrom, such as silicone elastomers produced by irradiation.

The crosslinking process in addition-crosslinking silicone compositions generally occurs via a hydrosilylation reaction in which platinum or another metal from the platinum group is normally used as the catalyst. In the reaction proceeding catalytically, aliphatically unsaturated groups are reacted with Si-bonded hydrogen in order to convert the addition-crosslinkable silicone composition into the elastomeric state via the formation of a network.

According to the prior art, the catalysts used are normally activated thermally, which means that the addition-crosslinkable silicone composition must be heated for the crosslinking operation. In this process, the silicone composition frequently has to be applied to a substrate, as is the case for example in coating processes and in selected potting, molding, and co-extrusion or other shaping processes. The actual vulcanization process is in this case effected through a heating process, for which costly and energy-intensive equipment often has to be operated.

The use of mixtures crosslinkable by means of ultraviolet and/or visible radiation is on the other hand associated in many applications with sometimes considerable savings on costs.

As a result, savings on energy and process costs and thus a corresponding increase in productivity can be achieved. In addition, crosslinking by means of ultraviolet and/or visible radiation often permits continuous production, which brings further productivity advantages compared to a discontinuous batchwise process. A further advantage arises from the fact that—particularly in the case of multipart components such as hard-soft composites that contain for example a thermoplastic as composite partner alongside an elastomeric material—dispensing with a high-temperature manufacturing step prevents the thermal warpage of the component.

The technical literature describes a multitude of platinum complexes suitable for initiation of a hydrosilylation reaction by means of radiation. All the platinum catalysts described can be activated by light and are capable of crosslinking silicone compositions even after the light source has been switched off. This operation is known to those skilled in the art as a dark reaction.

Dark stability describes, on the other hand, the stability of a composition comprising photoactivatable catalysts in the dark, i.e. ultimately the technically desirable storage stability of a composition. Inadequate dark stability is manifested for example by an increase in the viscosity of the mixture when small amounts of the catalyst react to form hydrosilylation-active species during storage. In addition, the catalyst can break down into inactive species during storage, as a result of which light-induced crosslinking is no longer able to take place.

EP 146 307 B1 discloses (η⁵-cyclopentadienyl) tri (σ-alkyl)platinum(IV) complexes characterized by good solubility in the silicone matrix.

EP 1 803 728 A1 discloses modified (η⁵-cyclopentadienyl) tri (σ-alkyl)platinum(IV) complexes bearing specific substituents (naphthyl, anthracenyl, etc.) on the cyclopentadienyl ring in order to increase the quantum yield and in order to shift the light wavelength needed for activation into the long-wave range. However, the attachment of aromatic rings has an adverse effect on the solubility of the complexes in the silicone matrix.

EP 2 238 145 B1 describes the attachment of (η⁵-cyclopentadienyl) tri (σ-alkyl)platinum (IV) complexes to polymers in order to reduce the volatility of this class of compounds. EP-A 3 186 265 describes modifications of the cyclopentadienyl ligand in (η⁵-cyclopentadienyl) tri (σ-alkyl)platinum(IV) complexes that contribute to an increase in dark stability.

In summary, it can be stated that none of the silicone compositions known to date that are crosslinkable via visible and/or UV radiation satisfactorily meets the requirements placed on silicone compositions of this type that can be used in particular for production in an industrial setting.

It was therefore an object of the present invention to provide silicone compositions that do not have the disadvantages mentioned above, in particular the inadequate dark stability.

The invention provides platinum-catalyzed compositions crosslinkable by hydrosilylation reaction, characterized in that the content of strong acids (S) having a pKa of <2.5 is less than 0.3 ppm by weight.

In the context of the present invention, the term “crosslinkable” should be understood as meaning any type of bond formed by hydrosilylation reaction, irrespective of whether these are part of a network or not.

The acids suitable as strong acids (S) are well known to those skilled in the art, for example from reference works, and are normally described with pKa values, the pKa values being determined in an aqueous medium. Reference here can be made e.g. to the EPA publication: “Product Properties Test Guidelines OPPTS 830.7370 Dissociation Constants in Water”.

The strong acids (S) are preferably those having a pKₐ of less than 1.5, more preferably having a pKₐ of less than 0.

Examples of strong acids (S) are hydrogen chloride, alkyl and aryl sulfonic acids, such as p-toluenesulfonic acid, methanesulfonic acid and trifluoromethanesulfonic acid, sulfuric acid, and acid-activated bleaching earths such as Tonsil® Supreme 114 FF (manufacturer Clariant).

In particular, the strong acids (S) are those selected from hydrogen chloride, methanesulfonic acid, trifluoromethanesulfonic acid, sulfuric acid, and acid-activated bleaching earths, most preferably hydrogen chloride.

A preferred embodiment of the invention relates to platinum-catalyzed compositions crosslinkable by hydrosilylation reaction, characterized in that the content of strong acids (S), selected from hydrogen chloride, methanesulfonic acid, trifluoromethanesulfonic acid, sulfuric acid, and acid-activated bleaching earths, preferably hydrogen chloride, is less than 0.3 ppm by weight.

Strong acids (S) are preferably introduced into silicone compositions via the raw materials and originate in particular from production processes for the raw materials of the compositions of the invention. For example, acidic catalysts such as phosphonitrilic chlorides are used for the production of polydimethylsiloxanes and are largely neutralized e.g. with amines, resulting in the formation of ammonium chlorides; however, it is possible that PNCl₂ units incorporated into polydimethylsiloxanes hydrolyze over time, thereby releasing hydrogen chloride. In addition, solids used, for example fumed silicas produced from chlorosilanes, may contain residual amounts of silicon-bonded chlorine or adsorbed hydrogen chloride. Hydrolysis and/or desorption then results in the release of hydrogen chloride.

In the compositions of the invention, the content of strong acids (S) is preferably less than 0.2 ppm by weight, more preferably less than 0.1 ppm by weight, in particular 0.

The compositions of the invention are preferably those containing

(i) at least one compound selected from the group comprising the compounds (A), (B), and (C), where

(A) is an organic compound and/or an organosilicon compound containing at least one radical having an aliphatic carbon-carbon multiple bond,

(B) is an organosilicon compound containing at least one Si-bonded hydrogen atom, and

(C) is an organosilicon compound containing SiC-bonded radicals having aliphatic carbon-carbon multiple bonds and Si-bonded hydrogen atoms,

with the proviso that the compositions comprise at least one compound having aliphatic carbon-carbon multiple bonds and at least one compound having Si-bonded hydrogen atoms, and

(ii) at least one

(D) platinum catalyst,

with the proviso that the content of strong acids (S) having a pKa of <2.5 is less than 0.3 ppm by weight.

The compounds (A), (B), and (C) used in the compositions of the invention are in accordance with the prior art preferably selected such that they can be converted into a crosslinked state. For example, compound (A) may have at least two aliphatically unsaturated radicals and (B) at least three Si-bonded hydrogen atoms, or compound (A) may have at least three aliphatically unsaturated radicals and siloxane (B) at least two Si-bonded hydrogen atoms, or, instead of compounds (A) and (B), it is possible to use a siloxane (C) having aliphatically unsaturated radicals and Si-bonded hydrogen atoms, such that crosslinking of the components is possible. Additionally possible are mixtures from (A), (B), and (C) of aliphatically unsaturated radicals and Si-bonded hydrogen atoms.

The molar ratios of the components (A), (B), and (C) used in accordance with the invention correspond to those known from the prior art. The platinum catalyst (D) is used in amounts such that, based on the Pt(0) content, the amounts of catalyst known from the prior art are likewise present in the composition of the invention.

The compound (A) used according to the invention may be silicon-free organic compounds having preferably at least two aliphatically unsaturated groups and organosilicon compounds having preferably at least two aliphatically unsaturated groups, or else mixtures thereof.

Examples of silicon-free organic compounds (A) are 1,3,5-trivinylcyclohexane, 2,3-dimethyl-1,3-butadiene, 7-methyl-3-methylene-1,6-octadiene, 2-methyl-1,3-butadiene, 1,5-hexadiene, 1,7-octadiene, 4,7-methylene-4,7,8,9-tetrahydroindene, methylcyclopentadiene, 5-vinyl-2-norbornene, bicyclo[2.2.1]hepta-2,5-diene, 1,3-diisopropenylbenzene, polybutadiene containing vinyl groups, 1,4-divinylcyclohexane, 1,3,5-triallylbenzene, 1,3,5-trivinylbenzene, 1,2,4-trivinylcyclohexane, 1,3,5-triisopropenylbenzene, 1,4-divinylbenzene, 3-methyl-1,5-heptadiene, 3-phenyl-1,5-hexadiene, 3-vinyl-1,5-hexadiene and 4,5-dimethyl-4,5-diethyl-1,7-octadiene, N,N′-methylenebis(acrylamide), 1,1,1-tris(hydroxymethyl)propane triacrylate, 1,1,1-tris(hydroxymethyl)propane trimethacrylate, tripropylene glycol diacrylate, diallyl ether, diallyl carbonate, N,N′-diallylurea, polyethylene glycol diacrylate, and polyethylene glycol dimethacrylate.

The silicone compositions of the invention preferably comprise as constituent (A) at least one aliphatically unsaturated organosilicon compound, it being possible to use any of the aliphatically unsaturated organosilicon compounds used to date in addition-crosslinking compositions.

When (A) is an organosilicon compound having SiC-bonded radicals with aliphatic carbon-carbon multiple bonds, it is preferably composed of units of the general formula

R¹¹ₐR¹²_{b}SiO_{(4-a-b)/2} (IV),

where

R¹¹ may be identical or different and is a hydroxyl radical or a monovalent, optionally substituted, aliphatically saturated hydrocarbon radical having 1 to 20 carbon atoms,

R¹² may be identical or different and is a monovalent, aliphatically unsaturated, optionally substituted hydrocarbon radical having 2 to 10 carbon atoms,

a is 0, 1, 2 or 3, preferably 1 or 2,

b is 0, 1, 2 or 3, preferably 0 or 1,

with the proviso that the sum a+b is ≤3 and that at least one aliphatically unsaturated radical R¹², preferably at least two aliphatically unsaturated radicals R¹², are present per molecule.

In organosilicon compounds (A) composed of units of the formula (IV), there are preferably no units in which b is different to 0 joined to one another.

Examples of radicals R¹¹ are alkyl radicals, such as the methyl, ethyl, propyl, isopropyl, tert-butyl, n-pentyl, isopentyl, neopentyl, tert-pentyl, n-octyl, 2-ethylhexyl, 2,2,4-trimethylpentyl, n-nonyl or octadecyl radical; cycloalkyl radicals, such as the cyclopentyl, cyclohexyl, cycloheptyl, norbornyl, adamantylethyl or bornyl radical; aryl or alkaryl radicals, such as the phenyl, ethylphenyl, tolyl, xylyl, mesityl or naphthyl radical; aralkyl radicals, such as the benzyl, 2-phenylpropyl or phenylethyl radical, and also the 3,3,3-trifluoropropyl, 3-iodopropyl, 3-isocyanatopropyl, aminopropyl, methacryloyloxymethyl, and cyanoethyl radical.

Radicals R¹¹ are preferably hydrocarbon radicals having 1 to 20 carbon atoms, optionally substituted with halogen atoms or cyano groups, more preferably the methyl, phenyl, 3,3,3-trifluoropropyl or cyanoethyl radical, in particular the methyl radical.

Examples of radicals R¹² are alkenyl and alkynyl radicals, such as the vinyl, allyl, isopropenyl, 3-butenyl, 2,4-pentadienyl, butadienyl, 5-hexenyl, undecenyl, ethynyl, propynyl or hexynyl radical; cycloalkenyl radicals, such as the cyclopentenyl, cyclohexenyl, 3-cyclohexenylethyl, 5-bicycloheptenyl, norbornenyl, 4-cyclooctenyl or cyclooctadienyl radical; alkenylaryl radicals, such as the styryl or styrylethyl radical, and also halogenated and heteroatom-containing derivatives of the abovementioned radicals, such as the 2-bromovinyl, 3-bromo-1-propynyl, 1-chloro-2-methylallyl, 2-(chloromethyl)allyl, allyloxypropyl or 1-methoxyvinyl radical.

Radicals R¹² are preferably hydrocarbon radicals having 2 to 10 carbon atoms that have a terminal carbon-carbon double bond, more preferably are the vinyl, allyl or 5-hexenyl radical, in particular the vinyl radical.

Examples of component (A) are 1,1,1,2,2,3,3,3-heptamethyl-2-vinyl-trisiloxane, Me₃Si—O—(SiMe₂O)ₓ—SiMe₂(CH═CH₂) where x≥0, (CH═CH₂)Me₂Si—O—(SiMe₂O)ₓ—SiMe₂(CH═CH₂) where x>0, Me₃Si—O—(SiMe₂O)ₓ—(SiMe(CH═CH₂)O)_{y}—SiMe₃ where x>0 and y>0, and also (CH═CH₂)Me₂Si—O—(SiMe₂O)ₓ—(SiMe(CH═CH₂)O)_{y}—SiMe₂(CH═CH₂) where x>0 and y>0, where Me is a methyl radical.

The organosilicon compounds (A) used in accordance with the invention have a viscosity at 25° C. of preferably 1 to 40 000 000 mPa·s, more preferably 50 to 1 000 000 mPa·s.

The viscosities are determined in accordance with DIN EN ISO 3219: 1994 (Polymers/resins in the liquid state or as emulsions or dispersions) and DIN 53019 (Measurement of viscosities and flow curves using rotational viscometers) at 25° C. on an Anton Paar MCR301 air-bearing rotational rheometer with plate/cone systems.

Organosilicon compounds (B) used may be any hydrogen-functional organosilicon compounds that have also been used to date in addition-crosslinkable compositions.

Organosilicon compounds (B) containing SiH-bonded hydrogen atoms are preferably those composed of units of the general formula

R¹³_{c}H_{d}SiO_{(4-c-d)/2} (V),

where

R¹³ may be identical or different and is as defined for radical R¹¹,

c is 0, 1, 2 or 3, preferably 1 or 2, and

d is 0, 1 or 2, preferably 1 or 0,

with the proviso that the sum c+d is <4 and the organosilicon compound has at least one Si-bonded hydrogen atom per molecule, preferably at least two Si-bonded hydrogen atoms.

Examples of component (B) are 1,1,1,2,2,3,3,3-heptamethyltrisiloxane, Me₃Si—O—(SiMe₂O)ₓ—SiMe₂H where x≥0, tetramethyldisiloxane, HMe₂Si—O—(SiMe₂O)ₓ—SiMe₂H where x>0, Me₃Si—O—(SiMe₂O)ₓ—(SiMeHO)_{y}—SiMe₃ where x>0 and y>0, and HMe₂Si—O—(SiMe₂O)ₓ—(SiMeHO)_{y}—SiMe₂H, where x>0 and y>0, where Me is a methyl radical.

The organosilicon compounds (B) used in accordance with the invention have a viscosity at 25° C. of preferably 100 to 40 000 000 mPa·s, more preferably 1000 to 500 000 mPa·s.

Constituents (A), (B) or (C) are preferably present in the crosslinkable compositions of the invention in an amount such that the molar ratio of SiH groups to aliphatically unsaturated groups is 0.1 to 20, more preferably 1.0 to 5.0.

Instead of components (A) and (B), the compositions of the invention may contain organosilicon compounds (C) having aliphatic carbon-carbon multiple bonds alongside Si-bonded hydrogen atoms. It is also possible for the compositions of the invention to comprise all three components (A), (B), and (C). If organosilicon compounds (C) are used, they are preferably those composed of units of the general formulas

R¹¹_{g}SiO_{4-g/2} (VII),

R¹¹ₕR¹²SiO_{3-h/2} (VIII), and

R¹¹ᵢHSiO_{3-i/2} (IX),

where R¹¹ and R¹² may be identical or different and are as defined above,

g is 0, 1, 2 or 3,

h is 0, 1 or 2, and

i is 0, 1 or 2, with the proviso that at least 2 radicals R¹² and at least two Si-bonded hydrogen atoms are present per molecule.

Examples of organopolysiloxanes (C) are those composed of SiO_{4/2}, R¹¹₃SiO_{1/2}, R¹¹₂R¹²SiO_{1/2}, and R¹¹₂HSiO_{1/2} units, so-called MQ resins, where these resins may additionally contain R¹¹SiO_{3/2} and R¹¹₂SiO_{2/2} units, and linear organopolysiloxanes essentially consisting of R¹¹₂R¹²SiO_{1/2}, R¹¹₂SiO_{2/2}, and R¹¹HSiO_{2/2} units, where R¹¹ and R¹² are as defined above.

The organopolysiloxanes (C) preferably have a viscosity of 0.01 to 500 000 mPa·s, more preferably 0.1 to 100 000 mPa·s, in each case at 25° C.

The components (A), (B), and (C) used in accordance with the invention are standard commercial products or can be prepared by processes commonly used in chemistry.

The platinum catalysts (D) are preferably those of the formula

R¹₃Pt{CpR²₅} (I),

where

Cp is the cyclopentadienyl radical,

R¹ may be identical or different and is a monovalent, optionally substituted, aliphatically saturated hydrocarbon radical, and

R² may be identical or different and is a hydrogen atom, SiC-bonded silyl radical or a monovalent, optionally substituted hydrocarbon radical.

Cyclopentadienyl radical Cp is common knowledge in the literature. In the context of the present invention, cyclopentadienyl radical Cp shall preferably be understood as meaning the cyclopentadienyl anion consisting of a singly negatively charged, aromatic five-membered ring system C₅R′₅—. Cyclopentadienylplatinum complexes for the purposes of the invention contain a cyclopentadienyl radical η⁵-bonded to a platinum-containing fragment M,

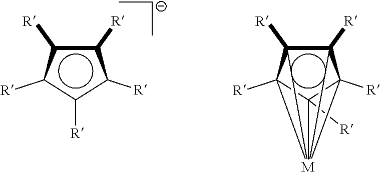

where R′ represents any desired radicals, which may also be joined to one another to form fused rings.

Examples of radicals R¹ are those defined above for radical R¹¹.

The radical R¹ is preferably hydrocarbon radicals optionally substituted by silyl radicals, more preferably methyl, trimethylsilylmethyl, cyclohexyl, phenylethyl or tert-butyl radicals, in particular methyl, trimethylsilyl-methyl or cyclohexyl radicals, most preferably the methyl radical.

Radical R² is an optionally substituted hydrocarbon radical and is monovalent or polyvalent, preferably monovalent. Two or more monovalent radicals R² may also form one or more rings fused to the cyclopentadienyl radical that may be aromatic, saturated or aliphatically unsaturated. It is also possible for a polyvalent radical R² to be attached to the cyclopentadienyl radical in more than one position, forming one or more rings fused to the cyclopentadienyl radical that may be aromatic, saturated or aliphatically unsaturated.

Examples of radicals R² are the examples given above for radicals R¹¹ and R¹² and also the hydrogen radical, vinyldimethylsilyl radical, allyldimethylsilyl radical, trimethoxysilylmethyl radical, trimethoxysilylpropyl radical, methyldimethoxysilylmethyl radical, methyldimethoxysilylpropyl radical, and methylbis(polydimethylsiloxy)silylpropyl radical.

The radical R² is preferably a hydrogen atom, SiC-bonded silyl radical or hydrocarbon radicals optionally substituted by silyl radicals, more preferably a hydrogen atom, methyl radical, allyldimethylsilyl radical, methyldimethoxysilylmethyl radical, methyldimethoxysilylpropyl radical or methylbis(polydimethylsiloxy)silylpropyl radical, in particular a hydrogen atom, methyl radical, allyldimethylsilyl radical, methyldimethoxysilylpropyl radical or methylbis(polydimethylsiloxy)silylpropyl radical, most preferably a hydrogen atom, methyl radical or methylbis(polydimethylsiloxy)silylpropyl radical.

Examples of platinum complexes (D) used in accordance with the invention are those mentioned in EP 2 238 145 B1, paragraphs [22] to [25] and paragraphs [30] to [31] and EP 3 186265 B, paragraphs [37] to [38], which count as part of the disclosed content of the invention.

The platinum complexes (D) used in accordance with the invention are preferably CpMePtMe₃, [(H₂C═CH—CH₂)Me₂SiCp]PtMe₃, CpPtMe₃, trimethyl[(3-diethoxymethylsilyl)propyl(allyldimethylsilyl)cyclopentadienyl]platinum(IV), trimethyl[(3-diethoxymethylsilyl)propylcyclopentadienyl]platinum(IV), trimethyl[(3-bis(polydimethylsiloxy)methylsilyl)propyl(allyldimethylsilyl)cyclopentadienyl]platinum(IV) or trimethyl[(3-bis(polydimethylsiloxy)methylsilyl)propylcyclopentadienyl]platinum(IV), more preferably CpMePtMe₃, trimethyl[(3-diethoxymethylsilyl)propyl(allyldimethylsilyl)cyclopentadienyl]platinum(IV), trimethyl[(3-diethoxymethylsilyl)propylcyclopentadienyl]platinum(IV), trimethyl[(3-bis(polydimethylsiloxy)methylsilyl)propyl(allyldimethylsilyl)cyclopentadienyl]platinum(IV) or trimethyl[(3-bis(polydimethylsiloxy)methylsilyl)propylcyclopentadienyl]platinum(IV), in particular CpMePtMe₃, trimethyl[(3-bis(polydimethylsiloxy)methylsilyl)propyl(allyldimethylsilyl)cyclopentadienyl]platinum(IV) or trimethyl[(3-bis(polydimethylsiloxy)methylsilyl)propylcyclopentadienyl]platinum(IV), where “polydimethylsiloxy” is understood as meaning polydimethylsiloxane units —(SiMe₂O)ₓ— where x=100-400 and where Me is a methyl radical.

The amount of platinum catalyst (D) used is guided by the desired crosslinking rate and by economic considerations. The amount of platinum catalyst (D) normally used per 100 parts by weight of crosslinkable composition is preferably 1·10⁻⁵ to 5·10⁻² parts by weight, more preferably 1·10⁻⁴ to 1·10⁻² parts by weight, in particular 5·10⁻⁴ to 5·10⁻³ parts by weight, in each case calculated as platinum metal.

In addition to the components (A), (B), (C), and (D) mentioned above, it is also possible for further components to be present in the compositions of the invention, for example inhibitors and stabilizers (E), fillers (F), and additives (G).

Components (E) serve for selective adjustment of the processing time, onset characteristics, and crosslinking rate of the compositions of the invention. These inhibitors and stabilizers are very well known in the field of addition-crosslinking compositions. Examples of common inhibitors are acetylenic alcohols, such as 1-ethynyl-1-cyclohexanol, 2-methyl-3-butyn-2-ol and 3,5-dimethyl-1-hexyn-3-ol, 3-methyl-1-dodecyn-3-ol, polymethylvinylsiloxanes containing neighboring siloxy groups with radicals having aliphatic carbon-carbon multiple bonds, and which have an inhibiting action, for example 1,3,5,7-tetravinyltetramethyltetracyclosiloxane, divinyltetramethyldisiloxane, and tetravinyldimethyldisiloxane, trialkyl cyanurates, alkyl maleates, such as diallyl maleate, dimethyl maleate, and diethyl maleate, alkyl fumarates, such as diallyl fumarate and diethyl fumarate, organic hydroperoxides such as cumene hydroperoxide, tert-butyl hydroperoxide, and pinane hydroperoxide, organic peroxides, organic sulfoxides, organic amines, diamines, and amides, phosphanes and phosphites, nitriles, triazoles, diaziridines, and oximes.

Component (E) is preferably acetylenic alcohols or alkyl maleates.

The effect of these inhibitor additions (E) depends on their chemical structure, and so the concentration must be determined individually. If inhibitors (E) are used, the amounts are preferably from 0.00001% to 5% by weight, more preferably 0.00005% to 2% by weight, particularly preferably 0.0001% to 1% by weight, in each case based on the total weight of the composition of the invention. It is preferable that the compositions of the invention comprise component (E).

Any fillers (F) used in the compositions of the invention may be any desired fillers known to date.

Examples of fillers (F) are non-reinforcing fillers, i.e. fillers having a BET surface area of preferably up to 50 m²/g, such as quartz, diatomaceous earth, calcium silicate, zirconium silicate, talc, kaolin, zeolites, metal oxide powders such as aluminum oxides, titanium oxides, iron oxides or zinc oxides or mixed oxides thereof, barium sulfate, calcium carbonate, gypsum, silicon nitride, silicon carbide, boron nitride, glass and polymer powders, such as polyacrylonitrile powder; reinforcing fillers, i.e. fillers having a BET surface area of more than 50 m²/g, such as precipitated chalks, carbon black, such as furnace black and acetylene black, and silicon-aluminum mixed oxides of high BET surface area; aluminum trihydroxide, hollow spherical fillers, such as ceramic microbeads, for example those available under the Zeeospheres™ 5 trade name from 3M Deutschland GmbH in Neuss, Germany, elastic polymer beads, for example those obtainable under the EXPANCEL® trade name from AKZO NOBEL, Expancel in Sundsvall, Sweden, or glass beads; fibrous fillers, such as asbestos, and polymeric fibers. The fillers mentioned may have been hydrophobized, for example by treatment with organosilanes or organosiloxanes or with stearic acid or by etherification of hydroxyl groups to alkoxy groups.

If the compositions of the invention comprise fillers (F), these are preferably fumed and precipitated silicas having BET surface areas of at least 50 m²/g.

Any fillers (F) used have a moisture content of preferably less than 1% by weight, more preferably less than 0.5% by weight.

If the compositions of the invention comprise fillers (F), the amounts are preferably 0.1% to 70% by weight, more preferably 1% to 50% by weight, in particular 10% to 30% by weight, in each case based on the total weight of the composition of the invention. It is preferable that the compositions of the invention comprise fillers (F).

Examples of optionally used components (G) are any other additives that have also been used to date for the production of addition-crosslinkable compositions, such as resinous polyorganosiloxanes other than the siloxanes (A), (B), and (C), fungicides, fragrances, organic rheological additives, corrosion inhibitors, oxidation inhibitors, light stabilizers other than the fillers (F), organic flame retardants and agents for influencing the electrical properties other than the fillers (F), dispersants, solvents, adhesion promoters, pigments, dyes, plasticizers other than the siloxanes (A), (B), and (C), organic polymers and heat stabilizers.

The additives (G) are preferably resinous aliphatically saturated polyorganosiloxanes free of Si-bonded hydrogen, organic solvents, adhesion promoters, pigments or dyes.

If the compositions of the invention comprise additives (G), the amounts are preferably 1% to 30% by weight, more preferably 1% to 20% by weight, in particular 1% to 5% by weight, in each case based on the total weight of the composition of the invention.

In a preferred embodiment of the invention, acid scavengers (H) are used in the production of the compositions of the invention, preferably in an at least stoichiometric amount for the content of strong acids (S).

Acid scavengers (H) used may be any substances suitable for reducing the content of strong acids (S) in the crosslinkable compositions; the acid scavengers themselves and their reaction products with strong acids must not have an adverse effect on the crosslinking of the compositions.

The acid scavengers (H) optionally used in accordance with the invention are preferably metal carbonates, metal carboxylates or basic phosphonates, more preferably metal carbonates or metal carboxylates, in particular metal carboxylates.

Examples of acid scavengers (H) are sodium hydrogen carbonate, lithium stearate, zinc stearate, zinc undecenylate, calcium 2-ethylhexanoate, calcium aluminum hydroxy carbonate, disodium hexadecyl phosphonate, potassium citrate, magnesium lactate, and sodium stearoyl-2-lactylate.

It is preferable that acid scavengers (H) are used in the production of the compositions of the invention.

If the compositions of the invention comprise acid scavengers (H), the amounts are preferably 0.001% to 3% by weight, more preferably 0.01% to 1% by weight, in particular 0.05% to 0.1% by weight, in each case based on the total weight of the composition of the invention. It is preferable that the compositions of the invention comprise acid scavengers (H).

Components (A), (B), and (C) and also (E), (F), (G), and (H) are preferably transparent below 400 nm, more preferably from 200 nm to 400 nm, such that light-induced crosslinking of the compositions can take place through activation of the catalyst (D).

The components used in accordance with the invention may each be one kind of such a component or a mixture of at least two kinds of any particular component.

If necessary, the compositions of the invention may be dissolved, dispersed, suspended or emulsified in liquids.

The compositions of the invention may—especially according to the viscosity of the constituents and filler content—be of low viscosity and pourable, have a pasty consistency, be pulverulent or else be pliable compositions of high viscosity, as can be the case, as is known, for the compositions commonly referred to among experts as RTV-1, RTV-2, LSR, and HTV. More particularly, the compositions of the invention, if they are highly viscous, can be prepared in the form of pellets. In this case, the individual pellet particles may comprise all the components, or the components used in accordance with the invention are incorporated separately into different pellet particles. As regards the elastomeric properties of the crosslinked silicone compositions of the invention, the whole spectrum is likewise covered, starting from extremely soft silicone gels through rubber-like materials up to and including highly crosslinked silicones having glass-like characteristics.

The compositions of the invention may be produced in any desired manner known per se, for instance by methods and mixing processes that are customary for the production of addition-crosslinking compositions.

The present invention further provides a process for producing the compositions of the invention by mixing the individual components in any desired order.

This mixing can take place at room temperature and ambient pressure, i.e. about 900 to 1100 hPa. If desired, this mixing can also take place at higher temperatures, for example at temperatures within a range from 30 to 130° C. In addition, it is possible to mix intermittently or constantly under reduced pressure, for example at 30 to 500 hPa absolute pressure, in order to remove volatile compounds and/or air.

The mixing according to the invention is preferably carried out with the exclusion of moisture and light having a wavelength of less than 500 nm.

The process according to the invention can be carried out continuously or batchwise.

In a preferred embodiment of the process of the invention, platinum catalyst (D) is mixed homogeneously with a mixture of (A), (B), and optionally (E), (F), (G), and (H). The platinum catalyst (D) used in accordance with the invention can be incorporated as the substance or in the form of a solution—dissolved in a suitable solvent—or as a so-called batch—mixed homogeneously with a small amount of (A) or (A) with (E).

If acid scavenger (H) is used, it can either be mixed with the individual constituents of the composition of the invention in a separate process or added to the mixture of two or more constituents of the preparation. For example, acid scavenger (H) can be mixed homogeneously with a mixture of (A), (B), and optionally (E), (F), (G), after which the platinum catalyst (D) used in accordance with the invention can be mixed in homogeneously as the substance or in the form of a solution—dissolved in a suitable solvent—or as a so-called batch. In this process, (H) and/or its derivative products with strong acids remain in the composition.

Acid scavenger (H) can also be used such that it is, as described, mixed with the individual constituents of the composition of the invention in a separate process or is added to the mixture of two or more constituents of the preparation. After a certain time, excess acid scavenger (H) is removed from the mixture together with the derivative products formed with the acid (S). For easier mixing and for better separability of acid scavenger (H) and/or derivative products thereof, e.g. by filtration, a suitable solvent in which the acid scavenger (H) and derivative products thereof are insoluble can be added to the mixture containing the acid scavenger (H) and/or derivative products thereof. In this process variant, compositions of the invention are obtained in which acid scavenger (H) and/or derivative products thereof are absent or present only in traces.

The compositions of the invention can be either one-component silicone compositions or two-component silicone compositions. In the latter case, the two components of the compositions of the invention may comprise all constituents in any desired molar ratios, it being preferable that one component comprises the platinum catalyst (D) and no Si—H-containing component (B) or (C).

The compositions of the invention that are crosslinkable by addition of Si-bonded hydrogen to an aliphatic multiple bond can be crosslinked under the same conditions as the compositions crosslinkable by hydrosilylation reaction that are known to date.

The crosslinking is preferably carried out at a pressure of 30 to 250 000 hPa, in particular at ambient pressure, i.e. about 900 to 1100 hPa, or at pressures that are customary in an injection molding machine, i.e. about 200 000 hPa.

The crosslinking is preferably carried out at a temperature of 0 to 100° C., in particular at 10 to 50° C.

The crosslinking is according to the invention initiated by irradiation, particularly by means of ultraviolet radiation (UV) at 230 to 400 nm, in particular 250 to 350 nm. Depending on the formulation, the catalyst, and the intensity of the UV radiation, the necessary irradiation time may preferably be less than 1 minute, more preferably less than 1 second. It is possible to use any radiation source having radiation components below about 400 nm. Wavelengths less than 230 nm should preferably not be used. Conventional low-, medium-, and high-pressure mercury lamps are suitable. Radiation sources such as fluorescent tubes and “black light” lamps are likewise suitable.

The necessary radiation density depends on many factors and corresponds to that of crosslinkable systems comprising e.g. Cp′PtMe₃ that correspond to the prior art. For example, the necessary radiation dose for the commercially available silicone composition SEMICOSIL® 912/ELASTOSIL® CAT UV (10:1) in the wavelength range from 250 to 350 nm (generated e.g. by a Fe-doped mercury lamp) is 1.5 J/cm² for 2 minutes, corresponding to a radiation density of 180 mW/cm².

The present invention further provides shaped bodies produced by crosslinking the compositions of the invention.

The compositions of the invention and the crosslinking products produced therefrom in accordance with the invention can be used for any purposes for which organopolysiloxane compositions crosslinkable to elastomers or elastomers have been used to date. This includes, for example, the silicone coating or impregnation of any desired substrates, the production of moldings, for example in injection molding processes, vacuum extrusion processes, extrusion processes, casting and compression molding, and impressions, use as sealing, embedding, and potting compounds, etc.

The crosslinkable compositions of the invention have the advantage that they can be produced economically in a simple process using readily obtainable starting materials.

The crosslinkable compositions of the invention have the further advantage that they have, when in the form of a one-component formulation, good storage stability at 25° C. and ambient pressure and crosslink only on irradiation with visible or ultraviolet radiation. The crosslinking time is in particular dependent on the duration and intensity of the radiation.

The compositions of the invention also have the advantage that they give rise, in the case of a two-component formulation, after mixing the two components, to a crosslinkable silicone composition that remains processable over a long period at 25° C. and ambient pressure, i.e. exhibit an extremely long pot life, and crosslink only on irradiation.

The present invention has the major advantage that it can be used with all known formulations and that light-crosslinkable compositions having excellent dark stability can be produced in a simple manner.

A further advantage is that there is no need for exactly stoichiometric addition of the acid scavengers in relation to the content of strong acids in the compositions.

The compositions of the invention additionally have the advantage that the crosslinked silicone rubbers obtained therefrom have excellent transparency.

The compositions of the invention also have the advantage that the hydrosilylation reaction does not slow with reaction time and does not automatically stop after the irradiation has ended. Regions that have not been directly exposed also cure, which is advantageous particularly in the case of detailed impressions or in the potting of electronic components. Crosslinking cannot be initiated by increasing the temperature, but it can be accelerated.

The compositions of the invention, particularly when using acid scavengers (H), have the advantage over the systems used to date that they bring about better dark stability, i.e. long storage stability of crosslinkable preparations.

In the context of the present invention, the term “organopolysiloxanes” encompasses polymeric, oligomeric and also dimeric siloxanes.

In the examples described below, all parts and percentages are by weight unless otherwise stated. Unless otherwise stated, the examples that follow are executed at ambient pressure, i.e. at about 1000 hPa, and at room temperature, i.e. about 20° C., or at the temperature attained on combining the reactants at room temperature without additional heating or cooling.

In the examples that follow, the acid concentrations of the compositions are determined based on ASTM D974. A selection of suitable indicators that is reasonable to those skilled in the art (e.g. quinaldine red, 4-o-tolylazo-o-toluidine, benzyl orange, tropaeolin, tetrabromophenolphthalein ethyl ester) is used to define a photometrically determinable neutralization point at which the concentration of all acids having a pKa of <2.5 is recorded.

The pKa is the pKa that the acids have in aqueous solution.

The following abbreviations are used: Me is the methyl radical and Vi is the vinyl radical.

### IR Spectroscopy

The development of the content of Si—H groups is determined by in-situ Fourier transform IR spectroscopy (FTIR). The Si—H group has a strong band in the range 2280-2080 cm⁻¹. The ReactIR 15 instrument from Mettler Toledo was used.

The ability of the compositions to undergo crosslinking by means of UV radiation was tested by irradiating a 5 mm thick layer of the composition for 10 seconds at 2000 W in a UV Cube (from Hoehnle; approx. 70 mW/cm²) using an iron radiation source of wavelength 230-400 nm.

Because of the sensitivity to light of the platinum catalysts used, the experiments were carried out in suitable lighting conditions (“yellow light room”, transmission <0.001% for λ<470 nm), i.e. the mixing and handling of all components aside from the platinum catalysts was carried out without special precautions as regards the lighting conditions. The mixing in of the platinum catalysts and the storage of mixtures comprising platinum catalysts took place under the special lighting conditions stated above or with complete exclusion of light.

The stated amounts of the platinum catalysts in the following examples are based on the platinum content contained therein in ppm by weight.

### EXAMPLE 1

A model composition is subjected to accelerated storage, i.e. stored at high temperature. Rapid reaction of the siloxanes by hydrosilylation, as can be demonstrated by a decrease in the Si—H content, is undesirable.

A flask is charged under argon as inert gas with a mixture of 1,1,1,2,3,3,3-heptamethyltrisiloxane (multiply distilled) and 1,1,1,2,3,3,3-heptamethyl-2-vinyltrisiloxane (multiply distilled) in a ratio of 1.5 mol/1.0 mol and this is heated to 100° C. The HCl content is 0.0 ppm. To this is added 250 ppm of CpMePtMe₃. The relative Si—H content is monitored by the ReactIR until no decrease in intensity is detectable. The point in time at which 50% of the total decrease in intensity (t_{50%}) has occurred is 15 hours.

The composition shows good stability.

### EXAMPLE 2

The procedure is as in example 1, except that 500 ppm of catalyst is used; t_{50%} is 9.5 h. The composition shows good stability.

### EXAMPLE 3

The procedure is as in example 1, except that 1000 ppm by weight of ammonium chloride (pKₐ=9.24) is additionally added as an example of a typical impurity in polydimethylsiloxanes; t_{50%} is 13 h. The composition shows good stability.

### COMPARATIVE EXAMPLE 1

The procedure is as in example 1, except that 1000 ppm by weight of p-toluenesulfonic acid (pKₐ=0.7) is additionally added; t_{50%} is 3.25 h. The composition does not show good stability.

### COMPARATIVE EXAMPLE 2

The procedure is as in example 1, except that 1000 ppm by weight of pyruvic acid (pKₐ=2.4) is additionally added; t_{50%} is 3.5 h. The composition does not show good stability.

### EXAMPLE 4

The procedure is as in example 1, except that 20 000 ppm by weight of potassium dihydrogen phosphate (pKₐ=6.82) is additionally added as an example of a typical impurity in polydimethylsiloxanes; t_{50%} is 13 h. The composition shows good stability.

### COMPARATIVE EXAMPLE 3

The procedure is as in example 1, except that 40 mg of hydrophilic fumed silica (BET=200 m²/g)/4 mL of siloxane mixture is additionally added (commercially available under the name HDK® V15 from Wacker Chemie AG), which contains traces of hydrogen chloride (pKₐ<1) in amounts of 10⁻³ mmol/g (pH determined in accordance with DIN EN ISO 787-9: 4.04); t_{50%} is 4.5 h. The composition does not show good stability.

### COMPARATIVE EXAMPLE 4

A mixture of 54.0 parts by weight of ViMe₂Si—O—(Me₂SiO)ₙ—SiMe₂Vi (viscosity 100 000 mPas), 7.5 parts by weight of ViMe₂Si—O—(Me₂SiO)ₙ—SiMe₂Vi (viscosity 20 000 mPas), 70 parts by weight of ViMe₂Si—O—(Me₂SiO)ₙ—SiMe₂Vi (viscosity 7000 mPas), 170 parts by weight of ViMe₂Si—O—(Me₂SiO)ₙ—SiMe₂Vi (viscosity 1000 mPas), and 44 parts by weight of (Me₃SiO_{1/2})ₓ(ViMe₂SiO_{1/2})_{y}(SiO_{4/2})_{z} where x+y/z=0.7 and x/y=7 (Mw 5300 g/ml, Mn 2400 g/mol) is mixed homogeneously. Additionally added to this are 3 parts by weight of Me₃Si—O—[(Me₂SiO)ₓ(MeHSiO)_{y}]—SiMe₃ (x+y=50, x/y=0.3/1, 1.1% Si—H) and 15 parts by weight of HMe₂Si—O—(Me₂SiO)ₓ—SiHMe₂ (x=60, 0.045% Si—H). The HCl content was determined to be 1.7 ppm by weight.

21.5 parts by weight of a solution of a catalyst trimethyl[(3-bis(polydimethylsiloxy)methylsilyl)propylcyclopentadienyl]platinum(IV) in ViMe₂Si—O—[(Me₂SiO)ₙ]—SiMe₂Vi (viscosity 1000 mPas) having a Pt content of 300 ppm by weight were mixed in. The overall mixture had an initial viscosity of 3761 mPas, a viscosity after 4 days at 25° C. of 7360 mPas, and was undesirably vulcanized after 7 days at 25° C.

### EXAMPLE 5

100 parts by weight of a composition according to comparative example 4 were, before addition of the platinum catalyst, diluted with 100 parts by weight of ethyl acetate and stirred with 1.5 parts by weight of NaHCO₃ as acid scavenger for 1 h at 25° C., filtered, and the volatile solvent removed. The HCl content was determined to be 0.0 ppm. 21.5 parts by weight of a solution of a catalyst trimethyl[(3-bis(polydimethylsiloxy)methylsilyl)propylcyclopentadienyl]platinum(IV) in ViMe₂Si—O—[(Me₂SiO)ₙ]—SiMe₂Vi (viscosity 1000 mPas) having a Pt content of 300 ppm by weight were mixed in. The overall mixture had an initial viscosity of 3176 mPas and a viscosity after 6 weeks at 25° C. of 3396 mPas.

Crosslinking by means of UV radiation was successful after 7 days of storage at 25° C. An elastomeric shaped body was obtained.

### COMPARATIVE EXAMPLE 5

A mixture of 230 parts by weight of ViMe₂Si—O—(Me₂SiO)ₙ—SiMe₂Vi (viscosity 20 000 mPas), 40 parts by weight of ViMe₂Si—O—(Me₂SiO)ₙ—SiMe₂Vi (viscosity 100 mPas), and 50 parts by weight of a hydrophobic fumed silica (BET=300 m²/g, commercially available under the name HDK® H30 from Wacker Chemie AG) is mixed homogeneously. Additionally mixed in to this are 9 parts by weight of Me₃Si—O—[(Me₂SiO)ₓ(MeHSiO)_{y}]—SiMe₃ (x+y=50, 1.1% Si—H), 2.5 parts by weight of glycidoxypropyltrimethoxysilane, and 5.0 parts by weight of methacryloyloxytrimethoxysilane. To this are added and mixed in 17.7 parts by weight of a solution of MeCpPtMe₃ in ViMe₂Si—O—[(Me₂SiO)ₙ]—SiMe₂Vi (viscosity 1000 mPas) having a platinum content of 300 ppm by weight (catalyst content of the overall mixture is 15 ppm by weight). The acid content is 13.5 ppm by weight of H⁺.

The viscosity is determined to be 24 200 mPas. After storage for 1/7 days at 25° C., the viscosity is 29 440/30 041 mPas. After storage for 7 days at 25° C., complete crosslinking by means of UV radiation was not achieved and a sticky skin had formed. After a further 24 h of storage at 25° C., uncrosslinked material can be detected under the skin.

### EXAMPLE 6

The procedure is as in comparative example 5, except that 0.05 parts by weight of zinc undecenylate are mixed in before adding the catalyst.

The viscosity is determined to be 24 000 mPas. After storage for 7/14/21 days at 25° C., the viscosity is 23 813/24 580/25 901 mPas.

Crosslinking by means of UV radiation was successful after 8 weeks of storage at 25° C. An elastomeric shaped body was obtained.

### EXAMPLE 7

The procedure is as in comparative example 5, except that 0.1 parts by weight of lithium palmitate are mixed in before adding the catalyst. The viscosity is determined to be 24 700 mPas. After storage for 7/14/21 days at 25° C., the viscosity is 23 839/24 762/26 477 mPas.

Crosslinking by means of UV radiation was successful after 8 weeks of storage at 25° C. An elastomeric shaped body was obtained.

1-10. (canceled)

11. A platinum-catalyzed composition, comprising:
wherein the platinum-catalyzed composition is crosslinkable by hydrosilylation reaction;
wherein the content of strong acids (S) has a pKa of <2.5 is less than 0.3 ppm by weight and that the platinum catalysts are those of the formula
R¹₃Pt{CpR²₅}
wherein Cp is the cyclopentadienyl radical;
wherein R¹ may be identical or different and is a monovalent, optionally substituted, aliphatically saturated hydrocarbon radical; and
wherein R² may be identical or different and is a hydrogen atom, SiC-bonded silyl radical or a monovalent, optionally substituted hydrocarbon radical.

12. The composition of claim 11, wherein the content of strong acids (S) are selected from hydrogen chloride, methanesulfonic acid, trifluoromethanesulfonic acid, sulfuric acid, and acid-activated bleaching earths and are less than 0.3 ppm by weight.

13. The composition of claim 11, wherein the content of strong acids (S) is less than 0.2 ppm by weight.

14. The composition of claim 11, wherein the composition further comprises:
(i) at least one compound selected from the group comprising the compounds (A), (B), and (C);
wherein compound (A) is an organic compound and/or an organosilicon compound containing at least one radical having an aliphatic carbon-carbon multiple bond;
wherein compound (B) is an organosilicon compound containing at least one Si-bonded hydrogen atom; and
wherein compound (C) is an organosilicon compound containing SiC-bonded radicals having aliphatic carbon-carbon multiple bonds and Si-bonded hydrogen atoms;
wherein the compositions comprise at least one compound having aliphatic carbon-carbon multiple bonds and at least one compound having Si-bonded hydrogen atoms, and
(ii) at least one platinum catalyst; and
wherein the content of strong acids (S) has a pKa of <2.5 is less than 0.3 ppm by weight.

15. The composition of claim 11, further comprising a constituent (A), wherein the constituent (A) comprises at least one aliphatically unsaturated organosilicon compound.

16. The composition of claim 11, further comprising acid scavengers (H).

17. The composition of claim 16, wherein the acid scavengers (H) are metal carbonates, metal carboxylates or basic phosphonates.

18. A process for producing the composition as claimed in claim 11, wherein the process comprises mixing the individual components in any desired order.

19. The process of claim 18, wherein the process produces a shaped body by crosslinking.

20. A shaped body produced by crosslinking the composition as claimed claim 11.
